(19) United States
(12) Patent Application Publication
(10) Pub. No.: US 2015/0333603 A1
(43) Pub. Date: Nov. 19, 2015

(54) Actuator

(71) Applicant: CONTINENTAL AUTOMOTIVE GMBH, Hannover (DE)

(72) Inventors: Joachim von WILLICH, Selters (DE); Christian REIMANN, Wehrheim (DE); Vinzent KREMINA, Frankfurt (DE)

(21) Appl. No.: 14/651,302

(22) PCT Filed: Dec. 12, 2013
(86) PCT No.: PCT/EP2013/076378

§ 371 Date: Jun. 11, 2015

(30) Foreign Application Priority Data
Dec. 14, 2012 (DE) 10 2012 223 297.4

(51) Int. Cl. H02K 11/00; H02K 9/22; H02K 5/08

(52) U.S. Cl. CPC H02K 11/0073; H02K 5/08; H02K 9/22

(57) ABSTRACT

An actuator including a metal housing that consists of multiple housing parts, an electric motor, an actuating member, a transmission mechanism that adapts the movement of the electric motor to the actuating member and an electronic system for controlling the electric motor. At least one housing part consists of is plastic, a heat sink being situated in the region of the housing part that consists of. The heat sink has thermal connecting surfaces for the electronic system and is connected to a metal housing part.

### CROSS REFERENCE TO RELATED APPLICATION

This is a U.S. national stage of application No. PCT/EP2013/076378, filed on Dec. 12, 2013. Priority is claimed on German Application No. DE102012223297.4, filed Dec. 14, 2012, the content of which is incorporated herein by reference.

### BACKGROUND OF THE INVENTION

1. Field of the Invention

The invention relates to an actuator comprising a metal housing that has a plurality of housing parts, an electric motor, an actuating member, a transmission mechanism that adapts the movement of the electric motor to the actuating member, and an electronics system for controlling the electric motor.

2. Detailed Description of the Prior Art

Actuators of this type have an actuating member that is driven by an electric motor. The actuator is in the form of a flap or a journal, or are used as actuators or valves in motor vehicles and are thus known. The metal housings are generally cast aluminum housings, since such housings have a sufficient strength with relatively low weight. To introduce the components into the housing, said housing has two or more housing parts. Since actuators are generally exposed to high temperatures in motor vehicles, the aluminum housing having a plurality of parts is used, on account of its good thermal conductivity, to cool the components arranged in the housing, in particular the electronics system. With use of the actuator in the high-temperature range, it is also known to provide an active cooling in the form of a water-cooling system in the housing. It is disadvantageous that the arrangement of a water-cooling system increases the cost for the aluminum housing significantly. In housings without water-cooling system, the housing parts must have relatively thick walls for sufficient thermal capacity in order to attain effective cooling. Such a housing thus has a relatively high weight.

### SUMMARY OF THE INVENTION

An object of one embodiment of the invention is an actuator that is constructed in a simple and economical manner. In addition, the actuator should have a low weight.

In one embodiment of the invention, at least one housing part comprises plastic, in that a heat sink is arranged in the region of the housing part comprising plastic, the heat sink has thermal connecting surfaces for the electronics system, and the heat sink is connected to a metal housing part.

The arrangement of a separate heat sink enables cooling of certain regions and/or components in the housing. This is particularly effective with heat-producing components, in particular the electronics system. Due to the cooling, components with lower thermal resistance and thus more economical components can be used. Since the cooling no longer has to be performed exclusively by the housing, the corresponding housing part may be made of a plastic, wherein the use of plastics that are resistant to high temperatures can also be omitted and instead more economical plastics can be used. The key advantage, however, lies in the fact that the actuator has a much lower weight due to the use of plastic.

In one embodiment the housing part is a plastic lid and the electronics system is secured to the plastic lid on account of the insulating properties of plastic. A separate securing of the electronics system can thus be spared. The plastic lid may have corresponding receptacles or domes, into which correspondingly shaped retaining elements, for example bores or latching points, of the electronics system can be clipped. Such receptacles can be produced in a simple manner by injection molding during the production of the lid. In accordance with a further embodiment additional retaining elements on the electronics system can be omitted when individual conductor paths are configured accordingly in order to clip into the receptacles of the plastic lid.

Effective cooling is achieved when a metal body is used as heat sink. On account of the thermal conductivity of metals, these materials are better suited than other materials. An improved cooling or the use of a smaller metal body as heat sink is achieved in that the metal body contains at least one metal having good thermal conductivity, preferably copper or aluminum.

In one embodiment, an improved heat dissipation from the electronics system is achieved in that the electronics system has heat transmission surfaces that are connected to the thermal connecting surfaces of the heat sink.

An unnecessary heating of the electronics system is avoided in that the heat transmission surfaces are arranged in the vicinity of electrical components of the electronics system that produce a large amount of heat. The heat is thus dissipated over a short path to the heat sink, without heating further regions of the electronics system.

In one embodiment an influencing of the electronics system can be avoided in that the thermal connecting surfaces have an electrically non-conductive coating, preferably made of plastic or paint. In some circumstances, however, such an influencing may be desirable, in particular when the housing is to be brought to a defined electrical level, which has advantages in terms of the electromagnetic compatibility. In these cases the transmission surfaces are electrically conductive, for example in that the metal body and the transmission surfaces are uncoated. Such a defined electrical level may be the electrical connection of the housing via the heat sink to parts of the electronics system that are connected to ground potential.

A particularly simple connection of the electronics to the heat sink is achieved via the thermal connecting surfaces when these surfaces are formed as regions curved convexly in the direction of the electronics system. On account of this shaping, the connecting surfaces generate a certain preload, whereby a close contact between heat sink and electronics system is attained. It is therefore possible to dispense with an additional fixed mounting of the heat sink on the electronics system. A further advantage of this embodiment lies in the fact that convexly curved regions can be produced relatively easily by embossing.

The thermal connecting surfaces can be formed in one embodiment as tabs bent in the direction of the electronics system. These regions to be produced by stamping are easily produced. On account of their design, they also have a preload in order to ensure reliable contact with the electronics system.

With large quantities of heat to be dissipated, the thermal capacity of the heat sink can be increased in a simple manner in that the thermal connecting surfaces are solid metal bodies, preferably cuboids or cylinders. With this embodiment the thermal transfer between a component to be cooled and the heat sink can be enlarged.

The solid metal bodies can be connected to the heat sink at low cost by bonding or soldering.

By pressing the solid metal body into recesses of the heat sink, the metal bodies can be connected to the heat sink without additives.

In accordance with one embodiment the heat sink is designed in a relatively simple manner when the heat sink has recesses for components of the actuator. As a result of these recesses, the heat sink is guided around the components and can retain an essentially flat form, which enables a simple structure and easier production.

The function as a heat sink is further improved when the metal body has webs that are in contact with the metal housing part to thus dissipate the heat into the housing parts. The webs can be angled at any angles relative to the heat sink. The housing for this purpose may also have receptacles with which the webs engage.

In order to ensure a reliable heat dissipation into the housing under harsh operating conditions as well, the webs in accordance with an advantageous embodiment are formed in such a way that they are in contact with the housing under preload. A preload is already achieved when the end of the webs is bent in an L-shaped, U-shaped or V-shaped manner. The preload is generated here by the spring effect of the end. The preload can be provided in one embodiment by the shape of the receptacle of the housing. For this purpose the receptacle may be formed for example with lead-in chamfers. Such a form additionally can be produced easily.

### BRIEF DESCRIPTION OF THE DRAWINGS

The invention will be described in greater detail on the basis of an exemplary embodiment. In the drawings:

FIG. 1 is a partial section of an actuator according to the invention;

FIGS. 2 and 3 are further sections of the actuator according to FIG. 1; and

FIG. 4 is the heat sink according to FIG. 1.

### DETAILED DESCRIPTION OF THE PRESENTLY PREFERRED EMBODIMENTS

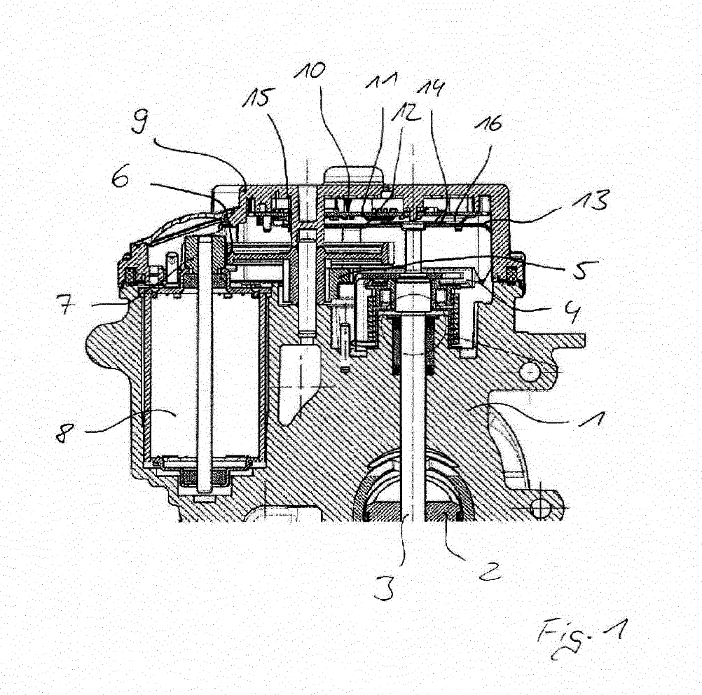

FIG. 1 shows part of an aluminum housing 1 of an actuator in a motor vehicle with an actuating member 2, driven via a shaft 3 and gearwheels 4-6 by a pinion 7 of an electric motor 8. The electric motor 8 is arranged in a chamber of the housing 1. A plastic lid 9 is connected to the housing 1. The plastic lid 9 covers a region of the electric motor 8 and the gearwheels 4-6. To control the electric motor 8 depending on the position of the actuating member 2, an electronics system 10 is provided. The electronics system 10 includes a printed circuit board 11 with electrical component parts 12 arranged thereon. A metal body acting as heat sink 13 is arranged between the gearwheels 4-6 and the electronics system 10. In a region of the shafts of the gearwheels 4-6, the heat sink 13 has recesses 14, 15. A tab 16 of the heat sink 13, as thermal connecting surface, is in contact with the electronics system 10 under preload.

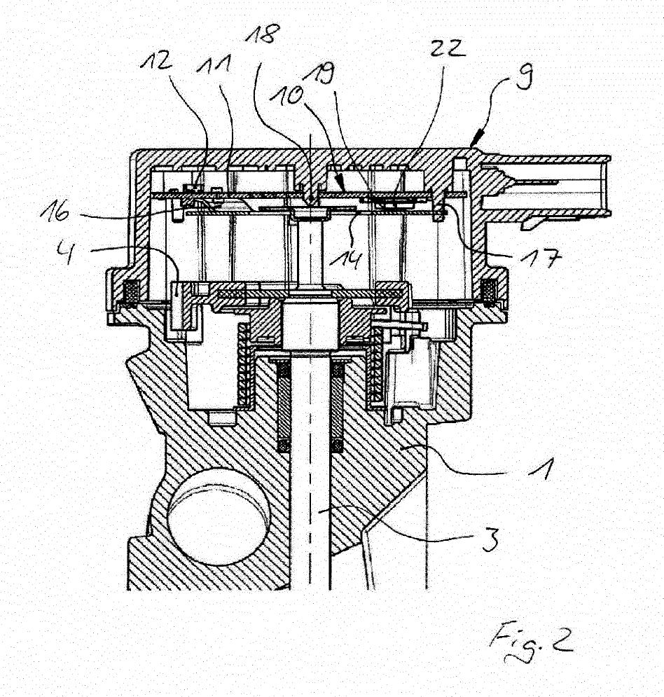

FIG. 2 shows the housing 1 with the plastic lid 9. In order to secure the electronics system 10 in the plastic lid 9, domes 17, are molded on the plastic lid 9, to which domes the electronics system 10 is connected or clipped. The thermal connection of the heat sink 13 to the electronics system 10 is established via the tab 16 and the region 19 curved convexly in the direction of the electronics system 11.

FIG. 3 shows the heat sink 13 with webs 20, 21, which are angled at a 90° angle from the heat sink 13 and are guided as far as the housing 1 of the actuator. The ends of the webs 20, are bent in a U-shaped manner to generate a wide bearing surface for the heat transfer and at the same time a preload, by which the heat sink 13 presses via its convex region 19 against the heat transmission surfaces 22.

All exemplary embodiments according to FIGS. 1-3 have the common feature that the heat sink 13 can be arranged, preferably overmolded, in the plastic lid 9 under lower thermal loads.

The electronics system 10 is connected via the tab 16 and/or the curved region 19.

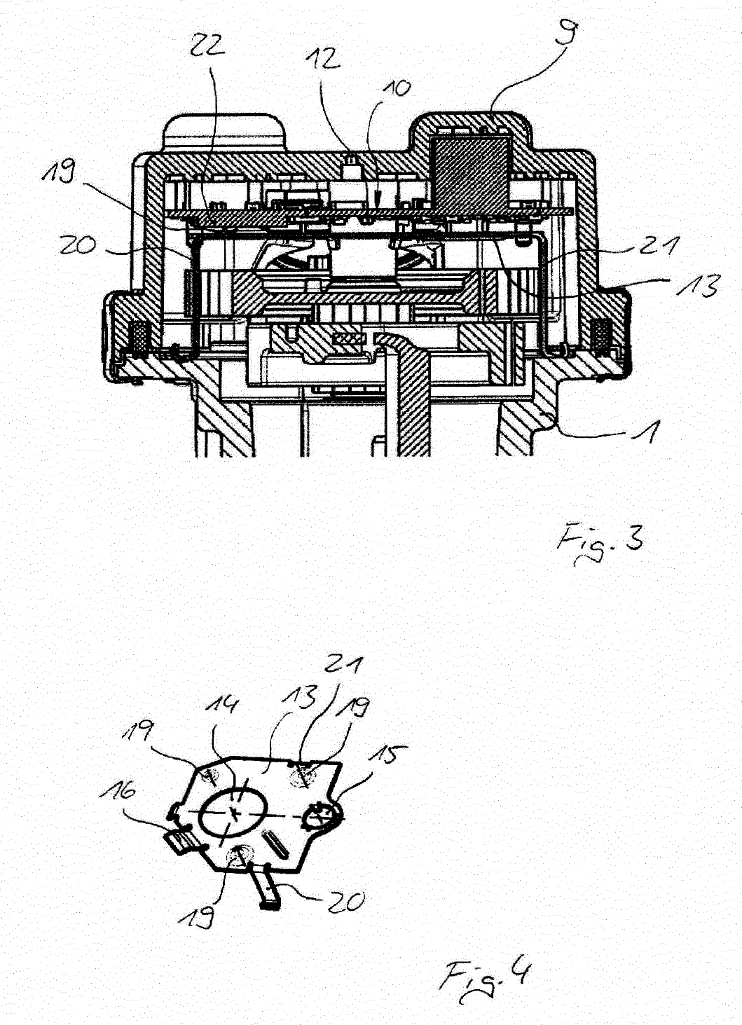

FIG. 4 lastly shows the heat sink 13 in a perspective illustration from above. The heat sink 13 is a metal body, which is produced by stamping from a sheet metal. The heat sink 13 has two webs 20, 21 angled downwardly by 90° for connection to the metal housing. An upwardly bent tab 16 and convexly upwardly curved regions 19 form the thermal connecting surfaces. The heat sink 13 also has two recesses 14, 15, with which components of the actuator may engage. As a result of the recesses 14, 15, the heat sink may have a substantially flat form, whereby the heat sink 13 can be produced more easily as a stamped part.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. An actuator comprising:
a housing having a plurality of housing parts, at least one housing part comprises plastic and at least one housing part comprises metal;
an electric motor arranged in the housing;
an actuating member;
a transmission mechanism that couples the electric motor to the actuating member;
an electronics system configured to control the electric motor; and
a heat sink arranged in a region of the at least one housing part that comprises plastic and is connected to a metal housing part,
wherein the heat sink has at least one thermal connecting surface for the electronics system.

18. The actuator as claimed in claim 17, wherein the at least one housing part that comprises plastic is a plastic lid.

19. The actuator as claimed in claim 17, wherein the heat sink is a metal body.

20. The actuator as claimed in claim 19, wherein the metal body contains at least one metal having good thermal conductivity.

21. The actuator as claimed in claim 17, wherein the electronics system has a thermal transmission surface coupled to the at least one thermal connecting surface of the heat sink.

22. The actuator as claimed in claim 21, wherein the thermal transmission surface is arranged in a vicinity of electrical components of the electronics system that produce heat.

23. The actuator as claimed in claim 17, wherein the at least one thermal connecting surface has an electrically non-conductive coating.

24. The actuator as claimed in claim 17, wherein the at least one thermal connecting surface is formed as a region curved convexly in a direction of the electronics system.

25. The actuator as claimed in claim 17, wherein the at least one thermal connecting surface is formed as a tab bent in a direction of the electronics system.

26. The actuator as claimed in claim 17, wherein the at least one thermal connecting surface is a solid metal body.

27. The actuator as claimed in claim 26, wherein the solid metal body is connected to the heat sink by one of bonding and soldering.

28. The actuator as claimed in claim 26, wherein the solid metal body is pressed into a recess defined in the heat sink.

29. The actuator as claimed in claim 17, wherein the heat sink has webs which are in contact with the metal housing part.

30. The actuator as claimed in claim 29, wherein the webs are formed such that they are in contact with the metal housing part under preload.

31. The actuator as claimed in claim 17, wherein the heat sink defines at least one recess with which at least one component of the actuator engages.

32. The actuator as claimed in claim 18, wherein the heat sink is arranged in the plastic lid.

33. The actuator as claimed in claim 20, wherein the at least one metal is at least one of copper and aluminum.

34. The actuator as claimed in claim 26, wherein the solid metal body is one of a cuboid and a cylinder.
